(19) United States
(12) Patent Application Publication
(10) Pub. No.: US 2024/0233684 A1
(43) Pub. Date: Jul. 11, 2024

(54) SYSTEM FOR DISPLAYING CRITICAL AND NON-CRITICAL INFORMATION

(71) Applicant: SAFRAN ELECTRONICS & DEFENSE, PARIS (FR)

(72) Inventors: Julien BONNET, MOISSY-CRAMAYEL (FR); Michael MONTOYA, MOISSY-CRAMAYEL (FR); Nicolas CHARRIER, MOISSY-CRAMAYEL (FR)

(21) Appl. No.: 18/557,881

(22) PCT Filed: Apr. 25, 2022
(86) PCT No.: PCT/EP2022/060921

§ 371 Date: Oct. 27, 2023

(30) Foreign Application Priority Data
Apr. 30, 2021 (FR) FR2104581

(51) Int. Cl. G09G 5/377

(52) U.S. Cl. CPC G09G 5/377; G09G 2358/00; G09G 2380/12

(57) ABSTRACT

A system for displaying critical and non-critical information on a screen includes, in the same housing, at least one electronic computing circuit and an electronic monitoring circuit. The electronic computing circuit is programmed to process the critical information to be displayed, construct at least one image from non-critical information and incorporate therein the critical information to be displayed in order to form, on an output of the electronic computing circuit, an image signal intended to be transmitted to the screen. The electronic monitoring circuit has an input connected to said output and is programmed to determine expected critical information for the display and to verify whether the image signal contains information corresponding to the expected critical information. Aircraft equipped with such a system.

### BACKGROUND OF THE INVENTION

The present invention relates to the field of displaying critical and non-critical information for piloting a vehicle, and more specifically, an aircraft.

In the avionic field, critical information is information of which knowledge is essential for piloting the aircraft and which, if it is erroneous, can directly lead to the loss of the aircraft. The main critical information comprises, for example, air speed, a skidding indicator, attitude indicator, altitude, vertical speed, and direction. For this reason, the device for displaying critical data is itself a critical element, the use of which onboard an aircraft is preceded by a qualification or certification procedure, comprising extensive testing aiming to demonstrate the robustness, the accuracy and the reliability of the display device in any circumstance. The design and the manufacturing of such a display device are expensive for these reasons.

To provide more comfort to the crew, it is known to display information in the cockpit, which is useful, without however being critical. This information comprises, for example, inside and outside temperatures, time data, data relating to the operation of aircraft equipment, navigation data and other information of this type. The device for displaying this information can be a display device which is itself non-critical, or the critical display device.

In more developed systems, it is provided to also display relatively complex non-critical information. According to a first example, this is mapping information, more specifically, so-called terrain rendered images representing, in three dimensions, the zone of the Earth's surface flown over by the aircraft. According to a second example, these are images coming from embedded cameras.

For the display of such complex information, a central processor (CPU) is used to process critical information in view of the display, a graphic processor (GPU) for constructing images incorporating non-critical information and the graphic representation of critical information (alphanumerical characters, symbols, curve, histogram, scale, etc.), and an FPGA-type circuit to transform these images into electrical signals making it possible to display images by a screen. As an example, conventionally, the central processor computes that it must plot a straight line from a point A (0, 0) to a point B (100, 100), and the graphic processor develops an image wherein all the pixels (i, j) are illuminated, for which i=j varying from 0 to 100.

Document WO-A-2011/066920 describes a display device making it possible to develop images comprising both critical information and non-critical information.

### AIM OF THE INVENTION

The invention, in particular, aims to be able to ensure that the critical information displayed has not been altered during its processing in view of it being displayed.

### SUMMARY OF THE INVENTION

To this end, a system for displaying critical and non-critical information on a screen according to the invention is provided, the system comprising, in the same housing, at least one electronic computing circuit (110) and an electronic monitoring circuit. The electronic computing circuit is programmed to process the critical information to be displayed, construct at least one image from the non-critical information, and incorporate therein the critical information to be displayed, in order to form, on an output of the electronic computing circuit, an image signal intended to be transmitted to the screen. The electronic monitoring circuit has an input connected to said output and is programmed to determine expected critical information for the display and to verify whether the image signal contains information corresponding to the expected critical information.

Thus, the presence of critical information is verified in the image signal intended to be transmitted to the display screen, which limits the risks of displaying critical information altered by the processing that it has undergone in view of it being displayed. The fact that the data to be displayed are processed in view of it being displayed by electronic circuits disposed in one single and same housing facilitates this verification.

The invention also aims for an aircraft equipped with a display screen connected to the output of the electronic command circuit of such a system.

Other features and advantages of the invention will emerge upon reading the description below of particular and non-limiting embodiments of the invention.

### BRIEF DESCRIPTION OF THE DRAWINGS

Reference will be made to the accompanying drawings, among which:

FIG. 1 is a top, partial, schematic view of an aircraft according to the invention;

FIG. 2 is a block diagram of a display system according to a first embodiment of the invention;

FIG. 3 is a block diagram of a display system according to a second embodiment of the invention;

FIG. 4 is a block diagram of a display system according to a third embodiment of the invention.

### DETAILED DESCRIPTION OF THE INVENTION

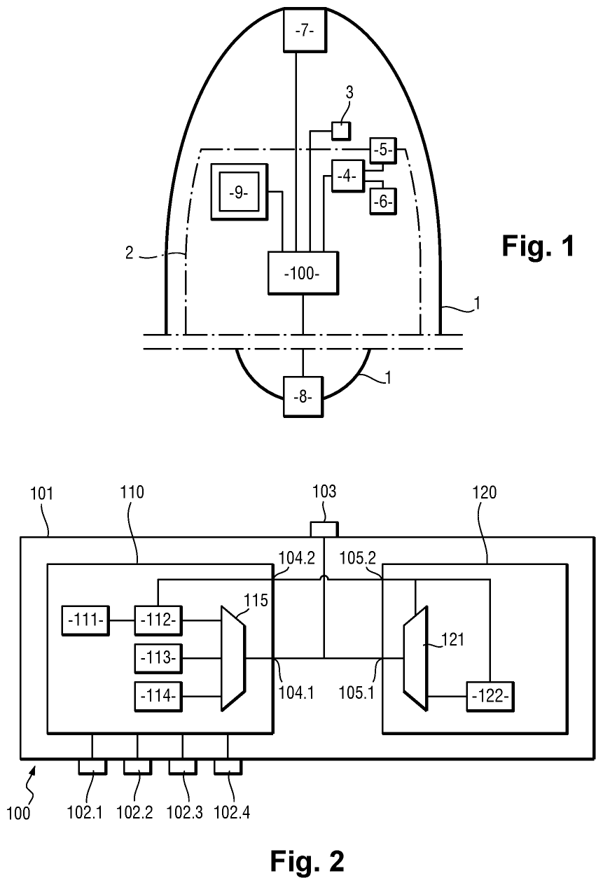

In reference to FIG. 1, the aircraft, in this case an aeroplane, comprises a fuselage 1, wherein a cockpit 2 is arranged.

The aircraft is provided with a certain amount of equipment providing information to the pilot, to enable them to pilot the aircraft and to safely take them from their departure point to their arrival point. Among this information, there are the following:
critical information enabling the pilot to take off and land the aircraft, and to keep it in flight; and
non-critical information making it possible, for example, for the pilot to visualise their environment.

Thus, in a manner known per se, the aircraft is provided with a set of external sensors 3 comprising:
a barometric altimeter 3 which provides, in association with an external temperature sensor, an altitude measurement from the atmospheric pressure surrounding the aircraft;
Pitot sensors to measure the air speed of the aircraft.

The altitude and the air speed of the aircraft form part of the critical information to be displayed.

The aircraft also embeds an electronic navigation unit 4 connected, on the one hand, to an inertial unit 5 comprising linear inertial sensors (accelerometers) and angular inertial sensors (gyroscopes or gyrometers) to provide inertial positioning data (altitude, position and speed) and, on the other hand, to a satellite signal receiver 6 arranged to provide satellite positioning data of the aircraft (pseudo-distances) from the signals coming from a satellite constellation belonging to a satellite positioning system (or GNSS; like GPS, GALILEO, GLONASS, BEIDOU systems, etc.). The electronic navigation unit 4, known per se, determines by hybridisation of inertial and satellite positioning data, a speed of the aircraft as well as a position of the aircraft transferred onto a map of the zone flown over. In this case, only attitude is focused on, provided by the inertial unit 5, which forms part of the critical information to be displayed.

A front camera 7 is mounted at the front of the fuselage 1 to provide, in the form of a video stream, images of the environment at the front of the aircraft. These images form part of the non-critical information to be displayed.

A rear camera 8 is mounted at the rear of the fuselage 1 to provide, in the form of a video stream, images of the environment at the rear of the aircraft. These images form part of the non-critical information to be displayed.

A display screen 9 connected to a display system generally referenced as 100 is mounted in the cockpit 2 to present the critical information and the non-critical information to the pilot. Naturally, the amount of information to be displayed could be different with more or less critical information and/or more or less non-critical information: this is an example to simply explain the invention.

The display system 100 comprises a housing 101 provided with connectors respectively defining at least one first input 102.1 connected to the barometric altimeter 3 to receive the altitude, a second input 102.2 connected to the electronic navigation unit 4 to receive the speed, a third input 102.3 connected to the front camera 7 to receive a video stream representing the front environment of the aircraft, a fourth input 102.4 connected to the rear camera 8 to receive a video stream representing the rear environment of the aircraft, and an output 103 to provide the corresponding electrical signal to the images to be displayed. The connectors forming the inputs 102.1 to 102.4 and the output 103 enable the electrical connection of the display system 100 to the equipment to which it is intended to be connected.

The housing 101 contains at least one electronic computing circuit 110 (commonly called COM) and an electronic monitoring circuit 120 (commonly called MON) connected to the electronic computing circuit 110. Each of these electronic circuits 110, 120 comprises at least one processor and a memory assembly containing computer programs which can be executed by the processor.

The computer programs executed by the processor of the electronic computing circuit 110 comprise instructions arranged such that the electronic computing circuit 110 forms a central processing unit (commonly called CPU) which processes (prepares and shapes) the critical information to be displayed, constructs an image from the non-critical information and incorporates therein the processed critical information, in order to form, on an output of the electronic computing circuit 110, an image signal intended to be transmitted to the display screen 8.

The computer programs executed by the processor of the electronic monitoring circuit 120 comprise instructions arranged such that the electronic monitoring circuit 120 determines expected critical information for the display and determines whether the image signal contains information corresponding to the expected critical information.

The different functions and tasks ensured by the electronic computing circuit 110 and by the electronic monitoring circuit 120 will now be described, in relation to FIGS. 2 to 4, in three embodiments.

The electronic computing circuit 110 ensures the same functions and tasks in the three embodiments. The electronic computing circuit 110 receives the altitude and the speed of the aircraft, which is the critical information, from the inputs 102.1, 102.2. The program executed by the electronic computing circuit 110 comprises a program part 111 arranged to group together the critical information and shape it, under which it will be displayed to thus obtain the critical information to be displayed.

A program part 112 executed by the electronic computing circuit 110 then incorporates the critical information to be displayed in a detail layer, called α, which comprises a transparent bottom and is intended to form an overprint layer in the images to be displayed.

The electronic computing circuit 110 receives the video stream from the front camera 7 through the input 102.3 and the video stream from the rear camera 8 through the input 102.4. The program executed by the electronic computing circuit 110 comprises program parts 113, 114 arranged to display the two video streams in two windows of a background detail layer of the image (conventionally called RGB layer).

A program part 115 then combines the background detail layer with the detail layer α such that the latter appears as an overprint on the background detail layer. The electronic computing circuit 110 provides an image signal (more specifically, a video stream) through an output 104.1 connected to the output 103 to which the screen 9 is connected.

In practice, the electronic computing circuit 110 can be programmed to emulate the operation of a graphic processing processor (commonly called GPU). The emulation program thus manages the production of detail layers and combining them. Such emulation programs are presently available on the market, and can be configured and used to achieve the invention.

The electronic computing circuit 110 can alternatively be programmed to use pre-computed images.

In a variant, the electronic computing circuit 110 can comprise at least one FPGA circuit forming a video accelerator arranged to combine the detail layers together. The FPGA circuit is thus preferably programmed to ensure at least some of the processing functions traditionally ensured by a GPU. Flight computers of aircrafts contain FPGA circuits which can be used for this purpose.

In the three embodiments also, the output 104.1 of the electronic computing circuit 110 is connected to an input 105.1 of the electronic monitoring circuit 120 making it possible for the electronic computing circuit 110 to transmit the image signal to the electronic monitoring circuit 120.

According to the first embodiment illustrated in FIG. 2, the electronic computing circuit 110 comprises an output 104.2 connected to an input 105.2 of the electronic monitoring circuit 120 making it possible for the electronic computing circuit 110 to transmit the detail layer α to the electronic monitoring circuit 120. The detail layer α comprises the critical information considered as expected by the electronic monitoring unit 120.

The electronic monitoring unit 120 executes a program, a part 121 of which is arranged to use the detail layer α received as a mask and apply it to the image signal received on the input 105.1 to obtain a result signal. A program part 122 executed by the electronic monitoring circuit 120 verifies from the result signal, that the detail layer α received through the input 105.2 is actually found in the image signal received on the input 105.1. Indeed, the result signal must correspond to the detail layer α received through the input 105.2, the other information being concealed. If so, the critical information is correctly displayed. If not, the critical information has been altered, either during combining, or during transfer between the computing unit 110 and the monitoring unit 120, or this is a failure of the monitoring unit 120: the electronic monitoring unit 120 emits an alert informing the pilot that they cannot consider the critical information displayed.

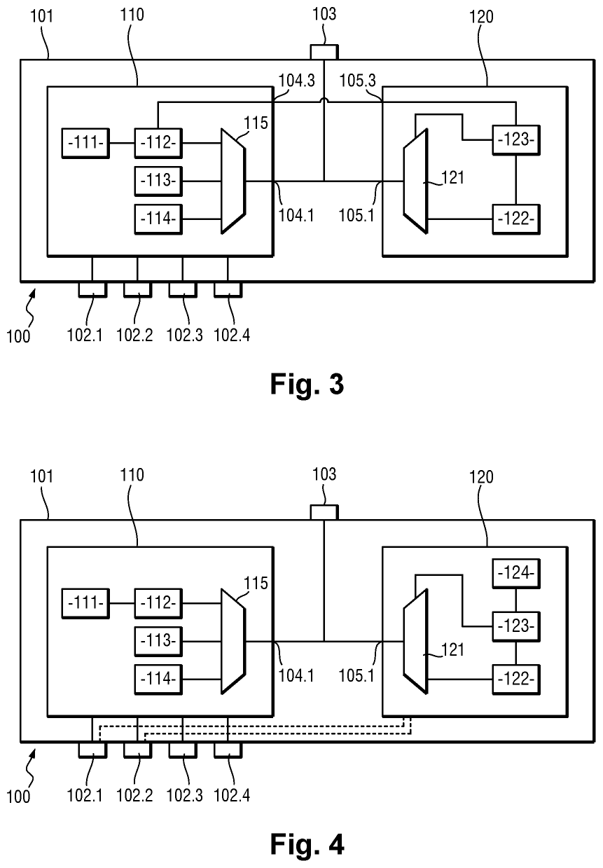

According to the second embodiment illustrated in FIG. 3, the electronic computing circuit 110 comprises an output 104.3 connected to an input 105.3 of the electronic monitoring circuit 120 making it possible for the electronic computing circuit 110 to transmit, to the electronic monitoring circuit 120, the processed critical information which will be considered as being the critical information expected by the electronic monitoring circuit 120.

The program executed by the electronic monitoring unit 120 comprises a program part 123 arranged to create the detail layer α incorporating the processed critical information received through the input 105.2 and transmit it to the program part 121 which will use it as a mask applied to the image signal received on the input 105.1 to obtain a result signal. The result signal corresponds to the image resulting from the filtering of the image received on the input 105.1 by using the layer α as a mask. The program part 122 executed by the electronic monitoring circuit 120 verifies from the result signal, that the detail layer α created by the electronic monitoring unit 120 is actually found in the image signal received on the input 105.1. Indeed, the result signal must correspond to the detail layer α created by the electronic monitoring unit 120, the other information being concealed. If so, the critical information is correctly displayed. If not, the critical information has been altered, either during the creation of the detail layer α by the electronic computing unit 110, or during combining, or during transfer between the computing unit 110 and the monitoring unit 120, or this is a failure of the monitoring unit 120: the electronic monitoring unit 120 emits an alert informing the pilot that they cannot consider the critical information displayed.

According to the third embodiment illustrated in FIG. 4, the electronic monitoring circuit 120 is connected to the inputs 102.1, 102.2 to directly receive the critical information.

The program executed by the electronic monitoring unit 120 comprises a program part 124 arranged to process, as the program part 111, the critical information from that received directly from the inputs 102.1, 102.2 to thus obtain the expected critical information. The critical information thus processed is theoretically identical to that produced by the electronic computing circuit 110 and is transmitted to the program part 123 which creates the detail layer α incorporating the critical information processed by the program part 124. The detail layer α created by the program part 123 is transmitted to the program part 121 which uses it as a mask applied to the image signal received on the input 105.1 to obtain a result signal. The program part 122 executed by the electronic monitoring circuit 120 verifies from the result signal, that the detail layer α created by the electronic monitoring unit 120 is actually found in the image signal received on the input 105.1. Indeed, the result image must correspond to the detail layer α created by the electronic monitoring unit 120, the other information being concealed. If so, the critical information is correctly displayed. If not, the critical information has been altered, either during development by the electronic computing unit 110, or during creation of the detail layer α by the electronic computing unit 110 or during combining, or during transfer between the computing unit 110 and the monitoring unit 120, or this is a failure of the monitoring unit 120: the electronic monitoring unit 120 emits an alert informing the pilot that they cannot consider the critical information displayed.

Naturally, the invention is not limited to the embodiment described, but includes any variant entering into the field of the invention such as defined by the claims.

In particular, the system can have a structure different from that described, and for example, several computing and/or monitoring units. The monitoring unit can comprise at least one voter (autonomous selector of the computing unit providing an image with the critical information considered correct) or at least one relay (piloted by another piece of equipment or a human).

For example, the electronic computing circuit 110 and the electronic monitoring circuit 120 can belong to one same electronic circuit. They can each be formed by one or more cores of one same processor. The electronic circuits 110 and 120 can form part of the same flight computer.

In a variant, the inputs 102 can be grouped together in a separate housing (interface module) connected by an electrical connection cable to the housing 101 which contains the computing and monitoring circuits.

The invention can be implemented by using one or more processors with one or more cores and/or one or more FPGA circuits incorporating one or more processors.

The critical and non-critical information can be provided by means other than those described, for example a radio altimeter for altitude.

The critical information can comprise information other than that mentioned.

The non-critical information can comprise operating parameters of the aircraft, meteorological data, images in the visible or infrared range, radar data, etc.

The non-critical information can further comprise terrain monitoring images. The aircraft thus comprises:
an altitude database containing the coordinates of the points of a grid of the territory flown over by the aeroplane and the altitudes associated with each point of this grid,
a photograph database containing the coordinates of the points of this same grid of the territory flown over by the aeroplane and aerial photographs associated with these points.

In a variant, the electronic computing circuit 110 has at least one input connected to a measurement source and the electronic monitoring circuit 120 has an input connected to said measurement source, the critical information to be displayed and the expected critical information therefore being obtained from the same measurement source. The electronic computing circuit 110 incorporates the critical information to be displayed in a first detail layer combined with at least one background detail layer to form the image to be displayed, the first detail layer also being transmitted to the electronic monitoring circuit 120.

The invention is applicable to any type of aircraft, to fixed or rotating airfoil, piloted or not, atmospheric or spatial, etc. The invention is also applicable to naval or land vehicles.

1. System for displaying critical and non-critical information on a screen, the system comprising, in one same housing, an output of which is connected to the screen, at least one electronic computing circuit and one electronic monitoring circuit, wherein the electronic computing circuit is programmed to process the critical information to be displayed, construct at least one image from the non-critical information and incorporate therein the critical information to be displayed in order to form, on an output of the electronic computing circuit, an image signal intended to be transmitted to the screen; and in that the electronic monitoring circuit has an input connected to said output of the electronic computing circuit and is programmed to determine the expected critical information for the display and verify whether the image signal contains information corresponding to the expected critical information.

2. System according to claim 1, wherein the electronic computing circuit has at least one input connected to a measurement source and the electronic monitoring circuit has an input connected to said measurement source, the critical information to be displayed and the expected critical information therefore being obtained from the same measurement source.

3. System according to claim 1, wherein the electronic computing circuit incorporates the critical information to be displayed in a first detail layer combined with at least one background detail layer to form the image to be displayed.

4. System according to claim 3, wherein the electronic monitoring circuit develops a second detail layer, wherein the expected critical information is incorporated.

5. System according to claim 4, wherein the electronic monitoring circuit uses the second detail layer as a mask applied to the image signal to obtain a result signal and verifies that the result signal corresponds to the second detail layer.

6. System according to claim 3, wherein the first detail layer is transmitted to the electronic monitoring circuit.

7. System according to claim 6, wherein the electronic monitoring circuit uses the first detail layer as a mask applied to the image signal to obtain a result signal and verifies whether the result signal corresponds to the first detail layer.

8. System according to claim 1, wherein the electronic computing circuit transmits the critical information to be displayed to the electronic monitoring circuit, and the electronic monitoring circuit considers said critical information to be displayed as the expected critical information and verifies whether the expected critical information is present in the image signal.

9. Aircraft equipped with at least one screen to which the output of a display system is connected, according to claim 1.
